(19) United States
(12) Patent Application Publication
(10) Pub. No.: US 2013/0045791 A1
(43) Pub. Date: Feb. 21, 2013

(54) GAMING SYSTEM, METHOD, AND PROGRAM PRODUCT PROVIDING INDETERMINATE GAME PLAY

(71) Applicant: Brian A. Watkins, Austin, TX (US)

(72) Inventor: Brian A. Watkins, Austin, TX (US)

(73) Assignee: Multimedia Games, Inc.

(21) Appl. No.: 13/211,639

(22) Filed: Aug. 17, 2011

(51) Int. Cl. A63F 13/00; A63F 9/24

(52) U.S. Cl. 463/25; 463/31

(57) ABSTRACT

A method for providing indeterminate play at a gaming machine may include setting a meter value for an indeterminate mode in response to some trigger condition. Once the meter is set for plays in the indeterminate play mode, an indeterminate play input may be received through the player input system of the gaming machine to initiate a respective play in the indeterminate play mode. The meter value may be incremented in response to a first type outcome for the respective play in the indeterminate play mode, decremented in response to a second type outcome for the play, and left unchanged in response to a third-type outcome for the play. These steps of receiving an outcome for a play in the indeterminate play mode and either incrementing, decrementing, or leaving the meter value unchanged may be repeated for each respective play in the indeterminate play mode until the meter value reaches a predetermined end value at which point the indeterminate play mode ends.

### COPYRIGHT NOTICE

A portion of the disclosure of this patent document contains material which is subject to copyright protection. The copyright owner has no objection to the facsimile reproduction of the patent document or the patent disclosure, as it appears in the U.S. Patent and Trademark Office patent files or records, but otherwise reserves all rights.

### BACKGROUND OF THE INVENTION

1. Field of the Invention

This invention relates to wagering games, gaming machines, gaming systems, and associated methods. More particularly, the invention relates to a wagering game which includes a play sequence having an indeterminate number of plays. The number of plays in this play sequence is determined by outcome types obtained during the course of a number of plays of the game.

2. Description of the Related Art

Numerous types of wagering games have been developed to provide players with new and varied gaming experiences. A bonus game which is offered in addition to a primary game is one popular feature. Bonus games may be offered in reel-type games, in playing card games, and in other types of primary games. Among the various types of bonus games which have been developed, free game bonuses are especially popular. In a free game bonus, the player is allowed to activate the gaming machine one or more times without having to make a wager for each activation as would normally be required. The player collects winnings associated with the respective outcome for each free game activation.

There remains a need in the wagering game field to provide wagering games which capture and maintain the player's interest and provide an entertaining and satisfying gaming experience. In particular, there remains a need to provide game play in a way that enhances the player's excitement and interest in participating in the game.

### SUMMARY OF THE INVENTION

Methods according to the present invention provide indeterminate play at a gaming machine for a wagering game. That is, the present invention provides a game play sequence, which may, for example, be a free game bonus, in which the number of plays allowed in the sequence is open-ended and not associated with any particular number of plays. Methods embodying the invention may include setting a meter value for an indeterminate play mode at a wagering game machine in response to some trigger condition for indeterminate play. Once the meter value is set for the indeterminate play mode, an indeterminate play input may be received through the player input system of the gaming machine to initiate a respective play in the indeterminate play mode. An outcome received for the respective play in the indeterminate play mode may comprise one of a first outcome type, a second outcome type, or a third outcome type. In response to the outcome received for the respective play in the indeterminate play mode, methods according to the present invention may include incrementing the meter value if the received outcome comprises the first outcome type, decrementing the meter value if the received outcome comprises the second outcome type, and leaving the meter value unchanged if the received outcome comprises the third outcome type. These steps of receiving an outcome for a play in the indeterminate play mode and either incrementing, decrementing, or leaving the meter value unchanged may be repeated for each respective play in the indeterminate play mode until the meter value reaches a predetermined end value. In response to reaching this predetermined end value, the gaming machine may be placed in a mode different from the indeterminate play mode, such as, for example, the mode of play in place immediately prior to the trigger condition for indeterminate mode play.

It will be appreciated that there is not necessarily any particular number of plays associated with entry into the indeterminate play mode according to the present invention. That is, there is not necessarily any set number of plays associated with play in the indeterminate play mode. Rather, the number of plays that a player may make when the gaming machine is in the indeterminate play mode is dictated by the effect the various indeterminate play outcomes have on the meter value. In one or more embodiments of the invention, the outcome that moves the meter value toward the end value has a higher probability of occurrence than the outcome that moves the meter value away from the end value. Thus the meter value will typically drift over a number of plays in the indeterminate play mode toward the predetermined end meter value at which point no further plays may be allowed in the indeterminate play mode. Although the invention is by no means limited to indeterminate play mode plays comprising free plays in a wagering game, the indeterminate play arrangement according to the present invention has particular application in controlling a free play bonus at a gaming machine.

A gaming machine according to one or more embodiments of the present invention includes at least one display device through which outcomes may be displayed for the various plays, and a player input system through which a player may make various inputs to initiate game plays in the indeterminate play mode and in other modes of play, such as regular wagering game play. At least one processor may be included in a gaming machine embodying the principles of the invention for controlling hardware and performing processing steps in accordance with instructions which may be stored in at least one memory device included in the gaming machine. In particular, the instructions may be executed by the processor to receive one or more game play inputs in a wagering game through the player input system, and to set the meter value for the indeterminate play mode in response to the trigger condition. Once the meter value is set for the indeterminate play mode, the processor or processors execute instructions to receive an indeterminate play input through the player input system, receive an outcome for the respective play in the indeterminate play mode, and change the meter value or leave the meter value unchanged according to the type of outcome. This process of receiving an input in the indeterminate play mode, receiving an outcome for that input, and modifying (or not modifying) the meter value accordingly, may be repeated until the meter value reaches the predetermined end value, and then the processor or processors execute instructions to place the gaming machine in some other mode of play other than the indeterminate mode.

The instructions which are executed by the processor or processors in a gaming machine implementing the present invention may comprise suitable program code. Thus the invention encompasses program products executable to provide various functions and operations to implement embodiments of the invention. A program product according to one or more forms of the present invention may include player input program code, game program code, display program code, indeterminate play program code, and payout program code. The player input program code in these embodiments is executable by at least one processor to receive the game play inputs entered through the gaming machine, while the game program code is executable to obtain an outcome for each respective play. The display program code is executable to cause the display device or perhaps multiple display devices associated with the gaming machine to display a graphical representation of the outcome for each respective play, and the payout program code is executable to award a prize for each respective outcome comprising a winning outcome. The indeterminate play program code in these forms of the invention may be executable by the processor or processors to set the meter value for the indeterminate play mode in response to the trigger condition. The indeterminate play program code may also be executable to modify the meter value according to each outcome in the indeterminate play mode or leave the meter value unchanged as dictated by the respective outcome, and place the gaming machine in a mode different from the indeterminate play mode once the meter value reaches the predetermined end value.

These and other advantages and features of the invention will be apparent from the following description of illustrative embodiments, considered along with the accompanying drawings.

### BRIEF DESCRIPTION OF THE DRAWINGS

FIG. 1 is a view in perspective of the front of a gaming machine which may be employed in embodiments of the present invention.

FIG. 2 is a diagrammatic representation of the gaming machine shown in FIG. 1 showing various components of the gaming machine.

FIG. 3 is a diagrammatic representation of a gaming network in which the present invention may be implemented.

FIG. 4 is a flow diagram illustrating a process flow according to one or more embodiments of the present invention.

FIG. 5 is a representation of a graphic presentation which may be produced on a display device showing a reel-type game in an indeterminate play mode according to one form of the present invention.

FIG. 6 is a representation similar to FIG. 5, but showing an incrementing outcome for a bonus play.

FIG. 7 is a representation similar to FIG. 5, but showing a decrementing outcome for a bonus play.

### DESCRIPTION OF ILLUSTRATIVE EMBODIMENTS

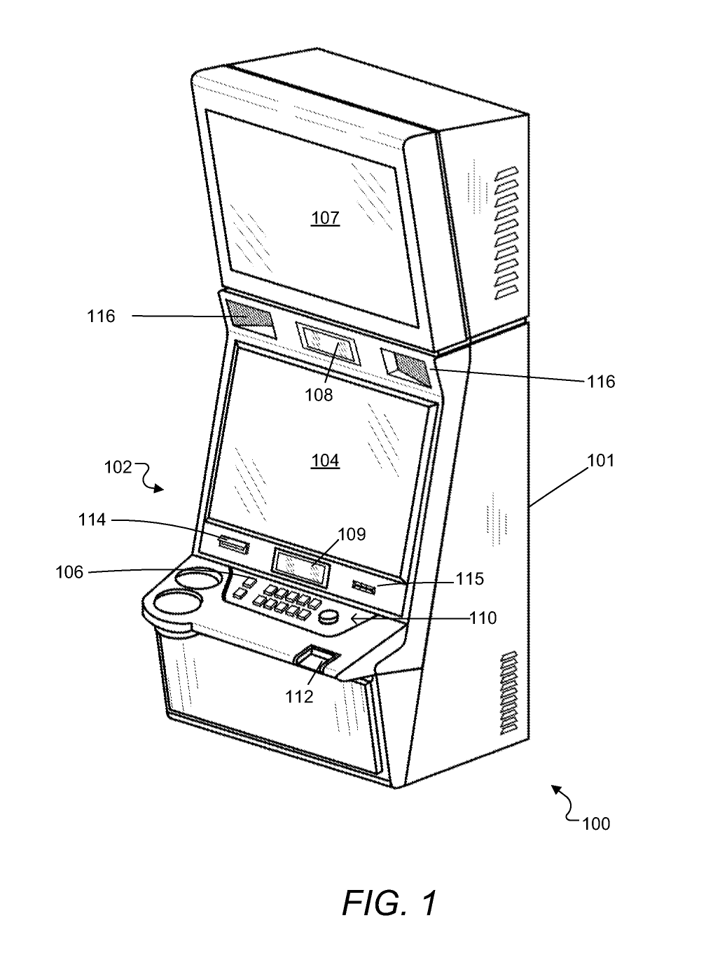

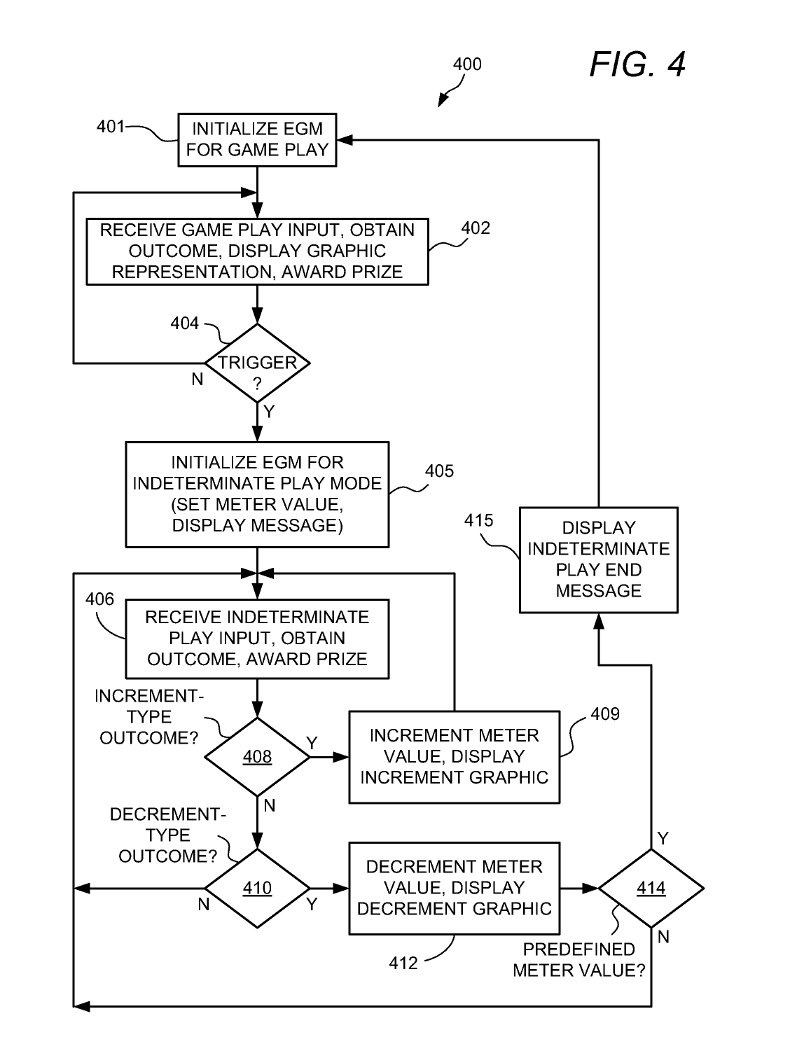

In the following description, FIGS. 1-3 will be used to describe an example gaming machine and gaming networks through which the present invention may be implemented. Example embodiments of the invention will then be described in connection with FIGS. 4-7.

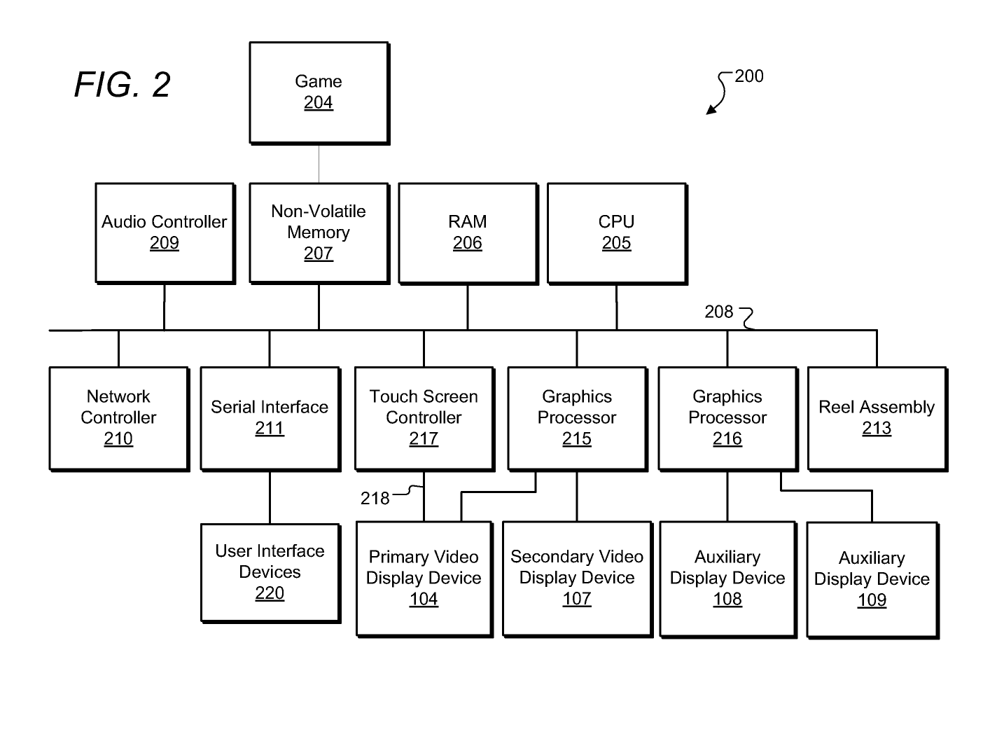

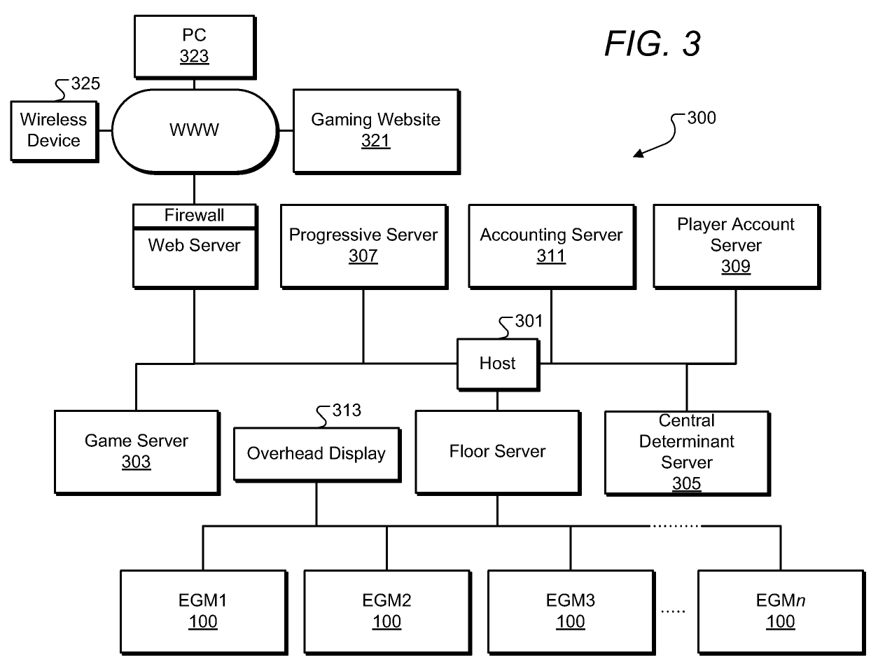

FIG. 1 shows a gaming machine 100 that may be used in implementing a game employing an indeterminate play sequence according to the present invention. The block diagram of FIG. 2 shows further details of gaming machine 100 along with certain variations which may be included in the gaming machine, while FIG. 3 shows an example gaming network in which gaming machines such as gaming machine 100 may be employed.

Referring to FIG. 1, gaming machine 100 includes a cabinet 101 having a front side generally shown at reference numeral 102. A primary video display device 104 is mounted in a central portion of the front surface 102, with a button panel 106 positioned below the primary video display device and projecting forwardly from the plane of the primary video display device. In addition to primary video display device 104, the illustrated gaming machine 100 includes a secondary video display device 107 positioned above the primary video display device. Gaming machine 100 also includes two additional smaller auxiliary display devices, an upper auxiliary display device 108 and a lower auxiliary display device 109. It should also be noted that each display device referenced herein may include any suitable display device including a cathode ray tube, liquid crystal display, plasma display, LED display, or any other type of display device currently known or that may be developed in the future. As will be described further below in connection with FIG. 2 and elsewhere, it is also possible for gaming machines within the scope of the present invention to include mechanical elements such as mechanical reels.

The gaming machine 100 illustrated for purposes of example in FIG. 1 also includes a number of mechanical control buttons 110 mounted on button panel 106. These control buttons 110 may allow a player to select a bet level, select pay lines, select a type of game or game feature, and start a play in a primary game. Other forms of gaming machines through which the invention may be implemented may include switches, joysticks, or other mechanical input devices, and/or virtual buttons and other controls implemented on a suitable touch screen video display. For example, primary video display device 104 in gaming machine 100 provides a convenient display device for implementing touch screen controls in addition to or in lieu of mechanical controls. The player interface devices which receive player inputs to initiate the play of a game through the gaming machine, such as controls to select a wager amount for a given play and control to actually start a given play, may be referred to generally as a player input system.

It will be appreciated that gaming machines may also include a number of other player interface devices in addition to devices that are considered player controls for use in playing a particular game. Gaming machine 100 also includes a currency/voucher acceptor having an input ramp 112, a player card reader having a player card input 114, and a voucher/receipt printer having a voucher/receipt output 115. Numerous other types of player interface devices may be included in gaming machines that may be used to implement embodiments of the present invention.

A gaming machine which may be used to implement embodiments of the present invention may also include a sound system to provide an audio output to enhance the user's playing experience. For example, illustrated gaming machine 100 includes speakers 116 which may be driven by a suitable audio amplifier to provide a desired audio output at the gaming machine.

FIG. 2 shows a logical and hardware block diagram 200 of gaming machine 100 which includes a central processing unit (CPU) 205 along with random access memory 206 and nonvolatile memory or storage device 207. All of these devices are connected on a system bus 208 with an audio interface device 209, a network interface 210, and a serial interface 211. A graphics processor 215 is also connected on bus 208 and is connected to drive primary video display device 104 and secondary video display device 107 (both mounted on cabinet 101 as shown in FIG. 1). A second graphics processor 216 is also connected on bus 208 in this example to drive the auxiliary display devices 108 and 109 also shown in FIG. 1. As shown in FIG. 2, gaming machine 100 also includes a touch screen controller 217 connected to system bus 208. Touch screen controller 217 is also connected via signal path 218 to receive signals from a touch screen element associated with primary video display device 104. It will be appreciated that the touch screen element itself typically comprises a thin film that is secured over the display surface of the respective display device, in this case video display device 104. The touch screen element itself is not illustrated or referenced separately in the figures.

Those familiar with data processing devices and systems will appreciate that other basic electronic components will be included in gaming machine 100 such as a power supply, cooling systems for the various system components, audio amplifiers, and other devices that are common in gaming machines. These additional devices are omitted from the drawings so as not to obscure the present invention in unnecessary detail.

All of the elements 205, 206, 207, 208, 209, 210, and 211 shown in FIG. 2 are elements commonly associated with a personal computer. These elements may be mounted on a standard personal computer chassis and housed in a standard personal computer housing which itself may be mounted in cabinet 101 shown in FIG. 1. Alternatively, the various electronic components may be mounted on one or more circuit boards housed within cabinet 101 without a separate enclosure such as those found in personal computers. Those familiar with data processing systems and the various data processing elements shown in FIG. 2 will appreciate that many variations on this illustrated structure may be used within the scope of the present invention. For example, since serial communications are commonly employed to communicate with a touch screen controller such as touch screen controller 217, the touch screen controller may not be connected on system bus 208, but instead include a serial communications line to serial interface 211, which may be a USB controller or a IEEE 1394 controller for example. It will also be appreciated that some of the devices shown in FIG. 2 as being connected directly on system bus 208 may in fact communicate with the other system components through a suitable expansion bus. Audio interface 209, for example, may be connected to the system via a PCI or PCIe bus. System bus 208 is shown in FIG. 2 merely to indicate that the various components are connected in some fashion for communication with CPU 205 and is not intended to limit the invention to any particular bus architecture. Numerous other variations in the gaming machine internal structure and system may be used without departing from the principles of the present invention. For example, a gaming machine in some embodiments of the present invention may rely on one or more data processors which are located remotely from the gaming machine itself. Embodiments of the present invention may include no processor such as CPU 205 or graphics processors such as 215 and 216 at the gaming machine, and may instead rely on one or more remote processors. Thus unless specifically stated otherwise, the designation “gaming machine” is used in this disclosure and the accompanying claims to designate a system of devices which operate together to provide the indicated functions. A “gaming machine” may include a gaming machine such as gaming machine 100 shown in FIGS. 1 and 2, which is itself a system of various components, and may also include one or more components remote from a gaming machine cabinet (such as cabinet 101 in FIG. 1). Thus the designation “gaming machine” encompasses both a stand-alone gaming machine and a gaming machine (that is, the part housed in a cabinet such as cabinet 101 in FIG. 1) along with one or more remote components for providing various functions (such as generating outcomes for plays in a game, and driving display devices mounted in a gaming machine cabinet).

It will also be appreciated that graphics processors are also commonly a part of modern computer systems. Although separate graphics processor 215 is shown for controlling primary video display device 104 and secondary video display device 107, and graphics processor 216 is shown for controlling both auxiliary display devices 108 and 109, CPU 205 or a graphics processor packaged with or included with CPU 205 may control all of the display devices directly without any separately packaged graphics processor. The invention is not limited to any particular arrangement of processing devices for controlling the video display devices included with gaming machine 100. Also, a gaming machine implementing the present invention is not limited to any particular number of video display device or other types of display devices.

In the illustrated gaming machine 100, CPU 205 executes software, that is, program code, which ultimately controls the entire gaming machine including the receipt of player inputs and the presentation of the graphic symbols displayed according to the invention through the display devices 104, 107, 108, and 109 associated with the gaming machine. CPU 205 also executes software related to communications handled through network interface 210, and software related to various peripheral devices such as those connected to the system through audio controller 209, serial interface 211, and touch screen controller 217. CPU 205 may also execute software to perform accounting functions associated with game play. Random access memory 206 provides memory for use by CPU 205 in executing its various software programs while the nonvolatile memory or storage device 207 may comprise a hard drive or other mass storage device providing storage for game software such as game program code 204 (and associated program code such as player input program code, display program code, indeterminate play program code, and payout program code) prior to loading into random access memory 206 for execution, or for programs not in use or for other data generated or used in the course of gaming machine operation. Network interface 210 provides an interface to other components of a gaming system in which gaming machine 100 may be included. An example network will be described below in connection with FIG. 3.

It should be noted that the invention is not limited to gaming machines employing the personal computer-type arrangement of processing devices and interfaces shown in example gaming machine 100. Other gaming machines through which indeterminate game play may be implemented may include one or more special purpose processing devices to perform the various processing steps for implementing the present invention. Unlike general purpose processing devices such as CPU 205, which may comprise an Intel Pentium® or Core® processor for example, these special purpose processing devices may not employ operational program code to direct the various processing steps.

The example gaming machine 100 which may be used to implement some embodiments of the present invention is shown in FIG. 2 as including a user interface devices 220 (part of a user interface system) connected to serial interface 211. These user interface devices may include various player input devices such as mechanical buttons shown on button panel 106 in FIG. 1, and/or levers, and other devices. It will be appreciated that the interface between CPU 205 and other player input devices such as player card readers, voucher readers or printers, and other devices may be in the form or serial communications. Thus user serial interface 211 may be used for those additional devices as well, or the gaming machine may include one or more additional serial interface controllers. However, the interface between peripheral devices in the gaming machine, such as player input devices, is not limited to any particular type or standard for purposes of the present invention.

Reel Assembly 213 is shown in the diagrammatic representation of FIG. 2 to illustrate that a gaming machine which may be used for various embodiments of the invention may include mechanical reels. For example, a set of mechanical reels may replace the primary display device 104, or at least part of that display device. Alternatively, mechanical reels may be included in the gaming machine behind a light-transmissive video display panel. Although the invention is not limited to any particular mechanical reel arrangement or control system, mechanical reels may be controlled conveniently through serial communications which provide instructions for a respective stepper motor for each reel. Thus some embodiments of the present invention which employ mechanical reels may use a serial interface device such as serial interface controller 211 to control communications with the reel assembly, and may not include a direct bus interconnection as indicated by FIG. 2. Details of a mechanical reel arrangement and various accent lighting arrangements which may be associated with mechanical reels are not shown in the present figures so as to avoid obscuring the present invention in unnecessary detail.

Referring now to FIG. 3, a networked gaming system 300 associated with one or more gaming facilities may include one or more networked gaming machines 100 (“electronic gaming machines” or “EGM's”) connected in the network by suitable network cable or wirelessly. Networked gaming machines 100 (EGM1-EGMn) and one or more overhead displays 313 may be operatively connected so that the overhead display or displays may mirror or replay the content of one or more displays of gaming machines 100. For example, the primary display content for a given gaming machine 100 may be stored by a display controller or game processor 205 of the given gaming machine and transmitted through network controller 210 to a controller associated with the overhead display(s) 313. In the event gaming machines 100 have cameras installed, the respective players' video images may be displayed on overhead display 313 along with the content of the player's gaming machine display.

The example gaming network 300 shown in FIG. 3 includes a host server 301 and floor server 302, which together may function as an intermediary between floor devices such as gaming machines 100 and back office devices such as the various servers described below. Game server 303 may provide server-based games and/or game services to network connected gaming devices such as gaming machines 100. Central determinant server 305 may be included in the network to identify or select lottery, bingo, or other centrally determined game outcomes and provide the information to networked gaming machines 100 which provide lottery and bingo-based wagering games to players.

Progressive server 307 may accumulate progressive awards by receiving defined amounts, such as a percentage of the wagers from eligible gaming devices or by receiving funding from marketing or casino funds. Progressive server 307 may also provide progressive awards to winning gaming devices in response to a progressive event. Such a progressive event may comprise, for example, a progressive jackpot game outcome or other triggering event such as a random or pseudo-random win determination at a networked gaming device or server. Accounting server 311 may receive gaming data from each of the networked gaming devices, perform audit functions, and provide data for analysis programs. Player account server 309 may maintain player account records, and store persistent player data such as accumulated player points and/or player preferences (for example, game personalizing selections or options).

Example gaming network 300 also includes a gaming website 321 which may be hosted through web server 320 and may be accessible by players via the Internet. One or more games may be displayed as described herein and played by a player through a personal computer 323 or handheld wireless device 325 (for example, a Blackberry® cell phone, Apple® iPhone®, personal digital assistant (PDA), iPad®, etc.). To enter website 321, a player may log in with a user name that may, for example, be associated with the player's account information stored on player account server 409. Once logged onto website 321 the player may play various games on the website. Also website 321 may allow the player to make various personalizing selections and save the information so it is available for use during the player's a next gaming session at a casino establishment having the gaming machines 100.

It will be appreciated that gaming network 300 illustrated in FIG. 3 is provided merely as an example of a gaming network in which games featuring indeterminate play according to embodiments of the present invention may be implemented, and is not intended to be limiting in any way. The invention is not limited to use in games offered through a gaming network (via the gaming website 321, or via gaming machines such as gaming machines 100, or otherwise). For example, games including indeterminate play according to the present invention may be offered through a stand-alone gaming machine having a configuration similar to gaming machine 100 or having any other gaming machine configuration. Also, where games including indeterminate play as described particularly below in connection with FIGS. 4-7 are offered through gaming machines included in a gaming network, the network need not have the configuration shown for purposes of example in FIG. 3. In particular, servers shown separately in the example of FIG. 3 may be combined in a single physical processing device, or the processing duties of the various illustrated servers may be split into additional physical devices.

FIG. 4 illustrates a process including indeterminate game play according to an example embodiment of the present invention. The figure shows a single indeterminate game play sequence in which a gaming machine is placed in an indeterminate play mode, and then placed in another play mode. It will be appreciated that this single sequence may be repeated numerous times for a given gaming session at a gaming machine.

The process 400 shown in FIG. 4 includes first initializing the gaming machine (EGM) for game play as shown at process block 401. This initializing step may include a number of different individual steps depending upon the nature of the gaming machine and the nature of the gaming network in which it may be included. For example, a gaming machine providing wagering games will typically require a player to insert cash or a credit voucher into a suitable device at the gaming machine to associate cash or credits with the gaming machine and allow the player to make wagers through the gaming machine. Some gaming machines may offer different games and thus receiving a game selection input may be included in the initializing process indicated that process block 401.

Regardless of the various inputs which may be received and steps taken to initialize gaming machine for play in a wagering game embodying the present invention, once the gaming machine is ready for play, the process includes receiving a game play input as shown at process block 402 in FIG. 4. The nature of this game play input may also vary significantly within the scope of the present invention. For example, although process block 402 indicates a single input, it will be appreciated that numerous separate inputs may be required and this collection of separate inputs may be treated as a game play input according to the present disclosure and the accompanying claims. For example, a game play input within the scope of the present invention may include player inputs to select a bet level and activate pay lines (where the game is a reel-type game) and may further include a separate play input made by pressing a “Play” button or pulling a handle at the gaming machine.

The process at block 402 further includes obtaining an outcome for the play of the game, displaying a graphic representation of the outcome, and awarding any prize associated with the outcome. The outcome for this game play input may be obtained in any number of ways within the scope of the present invention. For example, the gaming machine may include a random number generator that operates to randomly select an outcome from a number of possible outcomes according to a schedule of relative probabilities for the various outcomes. Alternatively, the gaming machine may randomly stop each reel of a set of actual or simulated spinning reels, and examine the reel stop positions to identify the outcome for the game. In yet other forms of the invention outcomes for the given game play input received at process block 402 may be obtained from a lottery game set or from an underlying game such as a bingo game. In any case, the process of obtaining an outcome for a game play will typically include a process which communicates a request for an outcome to an outcome generating process, and then receives the generated outcome.

The method by which prizes may be awarded is also subject to wide variation within the scope of the present invention. Prizes may be awarded by showing credit or currency value added to meters or displays shown at the gaming machine. This display of the added credit or currency at the gaming machine may or may not be accompanied by modifying a player or gaming session account maintained in a back office system. Prizes may also be awarded in a hand pay process in which a representative of the gaming facility where the gaming machine is located interacts with the player to award the prize. Typically, prizes are awarded according to a pay table which correlates a respective outcome in the game to a prize for that outcome. In particular, reel-type games include a pay table which correlates various reel symbol patterns to prizes. For playing card type games, the pay table for the game may correlate the various playing card hand values or rankings to various prize levels.

If the outcome obtained as indicated at process block 402 is not an outcome that triggers indeterminate play according to the invention, as indicated by a negative result at decision box 404, the process loops back to receive another game play input. However, if the outcome is associated with a trigger for the indeterminate play, the process proceeds to process block 405. According to this process step at block 405, the gaming machine is initialized for indeterminate play. This initializing step may include changing the graphic display at the gaming machine, changing games at the gaming machine or changing various characteristics of play, or displaying a message indicating to the player at the gaming machine that indeterminate play is about to begin, or any combination of one or more of these steps. It should also be noted that the initialization step shown at process block 405 may include essentially no change at the gaming machine other than setting the meter value as described below.

The meter value set at process block 405 is used as discussed below to determine when an additional play is available in the indeterminate play mode. The meter value may be associated with a numeric value or some other value. An example of a numeric value would be simply a number or a number represented by a corresponding number of displayed objects. One example of a normumeric meter value is an analog meter having a needle or other indicator that is moved one way (incremented) and the other (decremented) according to the method described further below. Some forms of the present invention may set the meter value at the same value for each session of play in the indeterminate play mode. Other forms of the invention may select different meter values at process block 405 depending upon the nature of the outcome which triggered the indeterminate play or some other factor. For example, in one implementation of the invention, a trigger for the indeterminate play at the gaming machine may be defined as the presence of some number of predefined scatter symbols in an outcome of a reel-type game. A first number of scatter symbols appearing in an outcome may cause the meter value to be set at a first level while more of the scatter symbols may cause the meter value to be set at a higher value. One particular form of the invention may include three different meter values which may be set according to process block 405, each meter value associated with a respective number of scatter symbols appearing in the trigger outcome. Of course, the invention is not limited to trigger outcomes based on scatter symbols in a reel-type game. Substantially any aspect of an outcome for a game play input at process block 402 may be used as a trigger for indeterminate play and any characteristic of the outcome may be used to set the meter value as shown at process block 405. Also, the meter value may be set randomly and the trigger may be random as well. Regardless of the form of the meter value and how the meter value is set, the meter value may be displayed through a suitable display device at the gaming machine at least for a portion of the time that the gaming machine is in the indeterminate play mode.

Once the gaming machine is initialized for indeterminate play (that is, the meter value is set and the gaming machine is in condition to receive an indeterminate play input to initiate a play for the indeterminate play mode) the example process shown in FIG. 4 includes receiving an indeterminate play input, obtaining an outcome for that input, and awarding a prize as shown at process block 406. All the variations described above regarding receiving a game play input and obtaining an outcome and awarding a prize as at process block 402 apply with equal force to the process shown at process block 406. However, it should be appreciated that some implementations of the present invention may not require any separate wager associated with an indeterminate play input received as indicated at process block 406. That is, the indeterminate play mode may be conducted as a free game. Alternatively, the wager necessary for a play in the indeterminate play mode may be modified (in particular, reduced) as compared to the game conducted according to process block 402.

In one or more embodiments, the outcomes possible at process block 406 may be characterized or divided into different outcome types. In particular, a set of one or more outcomes that are possible for a given play of the game in the indeterminate play mode may be defined as an increment-type outcome, a set of one or more outcomes may be defined as a decrement-type outcome, and these two different sets of outcomes may leave yet other outcomes which are included in neither set. If the outcome obtained as indicated at process block 406 is an increment-type outcome as indicated by a positive outcome at decision box 408, the process proceeds to increment the meter value as indicated at process block 409. The process may also include displaying a graphic (an increment graphic) associated with the increment-type outcome and incrementing the meter value. This increment graphic may alert the player that the meter value has been incremented and may include a separate message to that effect. Of course, the incremented value may also be displayed to the player in an appropriate fashion.

If the outcome for the play in the indeterminate play mode is a decrement-type outcome as indicated by a positive result at decision box 410, the process then proceeds to decrement the meter value as indicated at process block 412. Decrementing the meter value may also be associated with a particular graphic such as a separate message indicating that the meter value has been reduced in addition to a graphic representation of the meter value itself.

If decrementing the meter value at process block 412 causes the meter value to reach a predefined end value as indicated by a positive outcome at decision box 414, the process may display an indeterminate play end message as indicated at process block 415 and then return to initialize the gaming machine for game play in a mode other than in the indeterminate play mode as necessary according to process block 401. The message produced for the player as indicated at process block 415 may be any suitable graphic message or representation together with any suitable audio output to indicate that the indeterminate play has come to an end and that the gaming machine is switching from the indeterminate play mode to another mode.

The initializing step performed at process block 401 upon a branch of the process from decision box 414 may depend upon a number of factors, including the extent to which the gaming machine was modified in the initializing step shown at process block 405. If the game in the indeterminate play mode is the same game as in the play at process block 402, there may be very little graphic change at the gaming machine other than removing any visual indication of the meter value. On the other hand, if the initializing step at block 405 included changing the game at the gaming machine, the initializing step at 401, returning from steps 414 and 415, may include changing the game back to the game presented at the gaming machine prior to the step at process block 405. Some of these initializing steps may not be visible to the player, such as changing the reel symbols in a video reel-type game. It is also possible that the initializing step at process block 401 upon a return of the process through steps 414 and 415, may include changing the game at the gaming machine to a new game, that is a game different from the game in the indeterminate play mode and the game presented prior to the initialization at process block 405 in the given cycle through the process.

If the outcome obtained for the indeterminate play input received at process block 406 is neither an increment-type outcome nor a decrement-type outcome, the process returns back to receive another indeterminate play input at process block 406. That is, an outcome in the indeterminate play mode that is neither an increment-type outcome nor a decrement-type outcome leaves the meter value unchanged. Also, even if the outcome is a decrement-type outcome but the predefined meter value has not been reached as indicated by negative outcome at decision box 414, the illustrated example process 400 returns to receive another indeterminate play input at process block 406.

It will be appreciated from the process shown at 408, 409, 410, 412, and 414 that the indeterminate play mode according to the invention is not associated with any particular number of plays. Rather the meter value is maintained in order to determine whether indeterminate play should continue or end. Thus the player entering indeterminate play has the exciting prospect that the indeterminate play, which as noted above may be a free play of the game, may continue essentially indefinitely. However, despite the perception that play in the indeterminate play mode may continue indefinitely, implementations of the present invention may control outcome probabilities such that the probability of obtaining a decrement-type outcome (in the illustrated process) is somewhat higher than the probability of obtaining an increment-type outcome. Setting the probabilities in this fashion guarantees that the game eventually reaches the predefined value which ends indeterminate play. Aside from setting the outcome type probabilities to ensure that the predefined end meter value is eventually reached in a given sequence of indeterminate play, it may also be desirable to set an upper limit on the total number of plays allowed during a given round of indeterminate play. For example, the sequence of indeterminate play may be controlled such that indeterminate play terminates after 200 plays regardless of the meter value. This control process could be accomplished with a counter that counts the number of plays after the receipt of each play at process block 406 in FIG. 4, compares the new total to the predefined upper limit value, and branches to process block 415 if the count value is equal to the upper limit value.

It will be appreciated that numerous variations on the process shown for example in FIG. 4 are possible within the scope of the present invention. Perhaps most notably, the example process shown in FIG. 4 assumes that the predefined meter value which is reached to end play in the indeterminate mode is reached by decrementing the meter value. However, the invention encompasses situations in which the indeterminate play-ending meter value is a value that is reached by incrementing the meter value. That is, the indeterminate play ending meter value may be set as a low limiting value (as assumed in FIG. 4) or a high limiting value. Other variations within the scope of the invention relate to the incrementing or decrementing steps shown at 409 and 412, respectively, in the example process of FIG. 4. Some forms of the invention may increment or decrement the meter value in even steps, while other forms of the invention may increment or decrement the meter value in uneven steps. That is, some increment-type outcomes may increment the meter value more than others and some decrement-type outcomes may decrement the meter value more than others.

It should also be noted that some implementations of the invention may also include providing some fixed number of plays in an indeterminate play mode. For example, one form of the invention may allow at least five or some other number of plays in the indeterminate play mode prior to ending the indeterminate mode of play according to the meter value as described above. Alternatively, some number of plays may be tacked on to the plays in the indeterminate play mode once the end meter value is reached.

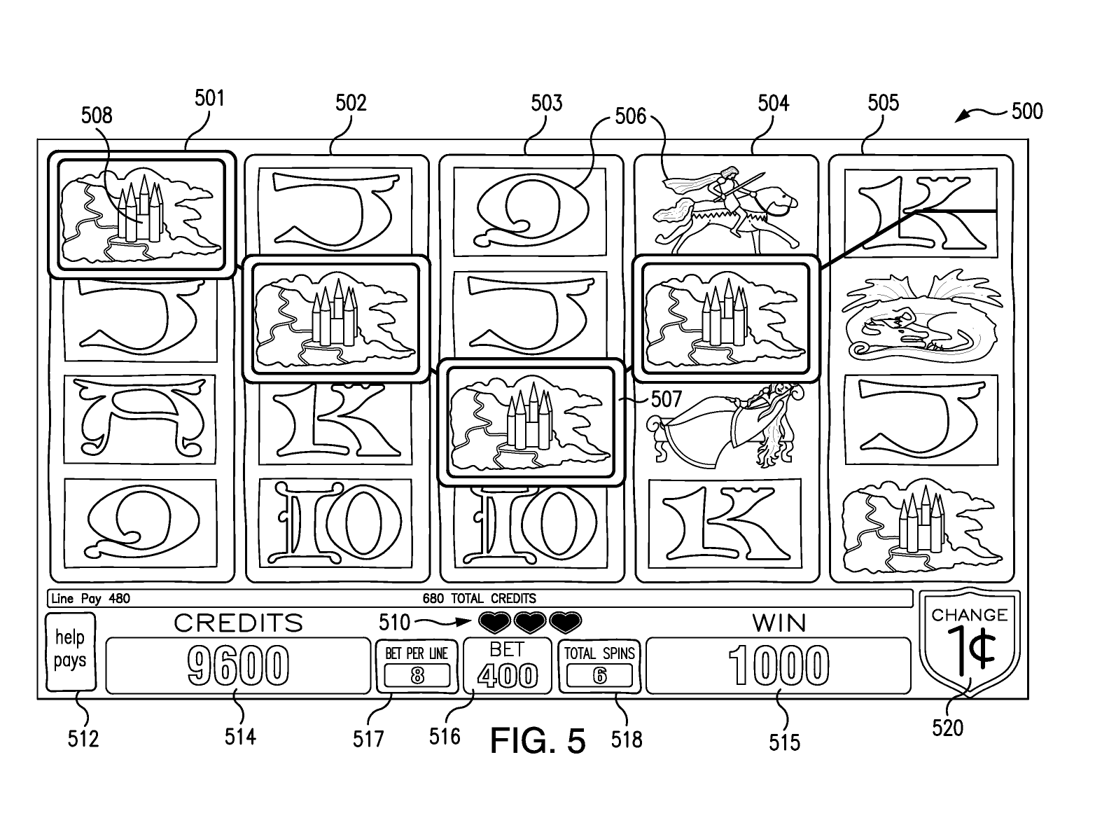

The example graphic presentations shown in FIGS. 5-7 may be used to describe one implementation of a process according to the invention. The particular game depicted in FIGS. 5-7 comprises a reel-type game, that is, a game in which an outcome for a given play is displayed at least partially through one or more symbol-bearing physical or virtual (video generated/simulated) reels. This particular example reel-type game is shown through a suitable video display device such as display 104 in FIG. 1. Each of FIGS. 5-7 shows an outcome that may be obtained in response to an indeterminate play input as shown at process block 406 in FIG. 4.

Referring to FIG. 5, the graphic presentation includes a display area 500 containing five video-generated reels, 501, 502, 503, 504, and 505. Each reel 501-505 in the stop position shown in FIG. 5 displays four symbol locations 506 to define a five-by-four matrix of symbols. As is known in the field of reel-type games, the patterns of symbols appearing in the symbol matrix may define or display results in the game. The particular graphic shown in FIG. 5 includes a highlighted winning V-shaped payline 507 including four castle symbols 508 aligned along the payline. This winning combination would be related to a prize level in a pay table which would typically be displayed at the gaming machine but is not shown in FIG. 5.

The graphic presentation shown in FIG. 5 also includes a graphic representation of the meter value which is set in an indeterminate play mode according to various embodiments of the present invention. This graphic representation of the meter value is shown generally at 510 in FIG. 5, and includes a number of hearts displayed immediately below the area including the five reels 501-505. The example game graphic shown in FIG. 5 also includes help button 512 (virtual button in this case), a display 514 for credits available to the player, a display 515 showing an amount won for a given play of the game, a bet display 516, a bet per line display 517, a total spins display 518 which shows the total number of spins thus far in the indeterminate play mode, and a denomination button (virtual button) 520.

Although the outcome shown in the graphic of FIG. 5 includes the highlighted winning payline 507, the outcome is neither an increment-type outcome nor a decrement-type outcome. Thus the outcome shown in FIG. 5 for the given indeterminate play input has no affect on the meter value being maintained for this sequence of plays in the indeterminate play mode, and displayed at the meter value display 510. It will be appreciated that any outcome or type of outcome possible in the game may be defined as an outcome which does not affect the meter value according to the present invention. The outcome need not comprise a winning outcome or a losing outcome. However, it will be advantageous to define outcomes which do not affect the meter value in a way that makes the outcome readily identifiable to the player.

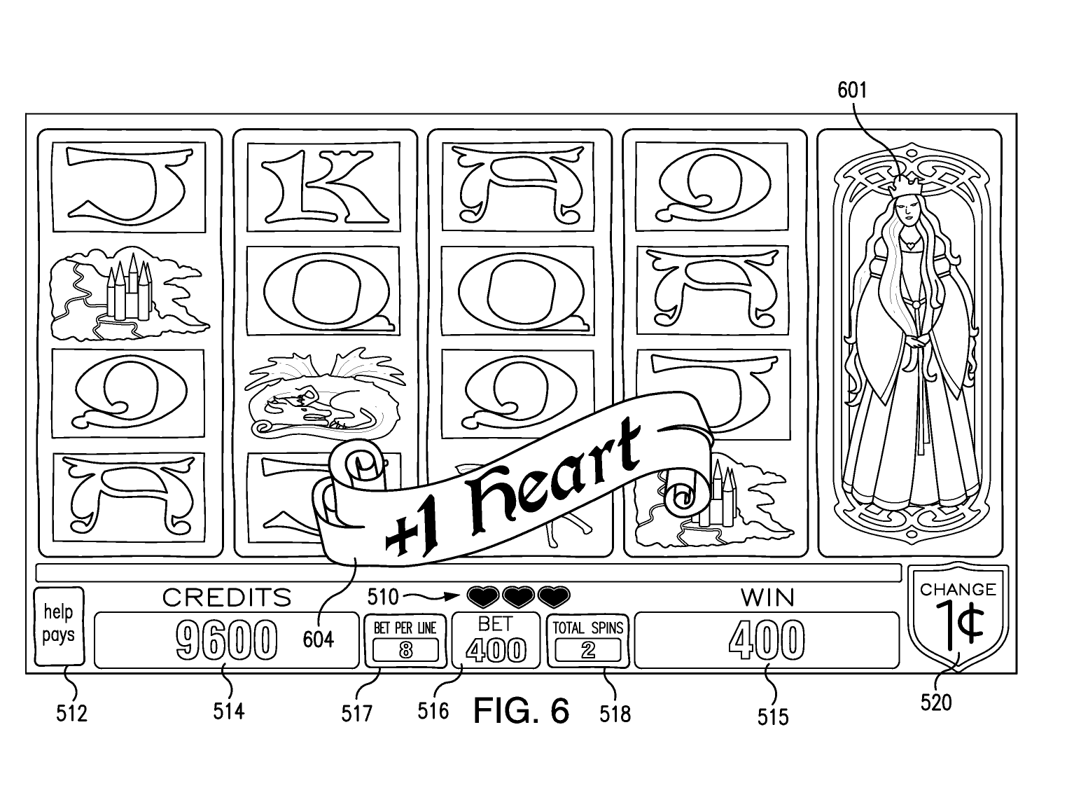

FIG. 6 shows a graphic presentation similar to FIG. 5, but with each simulated reel 501-505 stopped in a different position to show different symbols as compared to those shown in FIG. 5. This particular outcome shown in FIG. 6 is an example of an outcome (obtained at process block 406 in the process of FIG. 4 for example) which comprises an increment-type outcome. This particular outcome shows a special reel symbol 601 which spans all four symbol locations for the fifth reel 505. In one or more embodiments of the invention, this stacked or multi-symbol location symbol 601 may be configured to nudge to the position shown in FIG. 6 if any portion of the symbol stops at a symbol location of the reel. That is, if any portion of symbol 601 is shown in the stop position of reel 505 for a given play in the game (that is, a given spin), then the reel is shown as moving until symbol 601 is in the position shown in FIG. 6, occupying all four symbol locations on reel 505. In any event, since this particular outcome is an increment-type outcome, the outcome causes the meter value to be incremented. The increment value in this particular case is indicated by the increment graphic 604 including the label “+1 heart” which is shown over a portion of the reel area of display area 500.

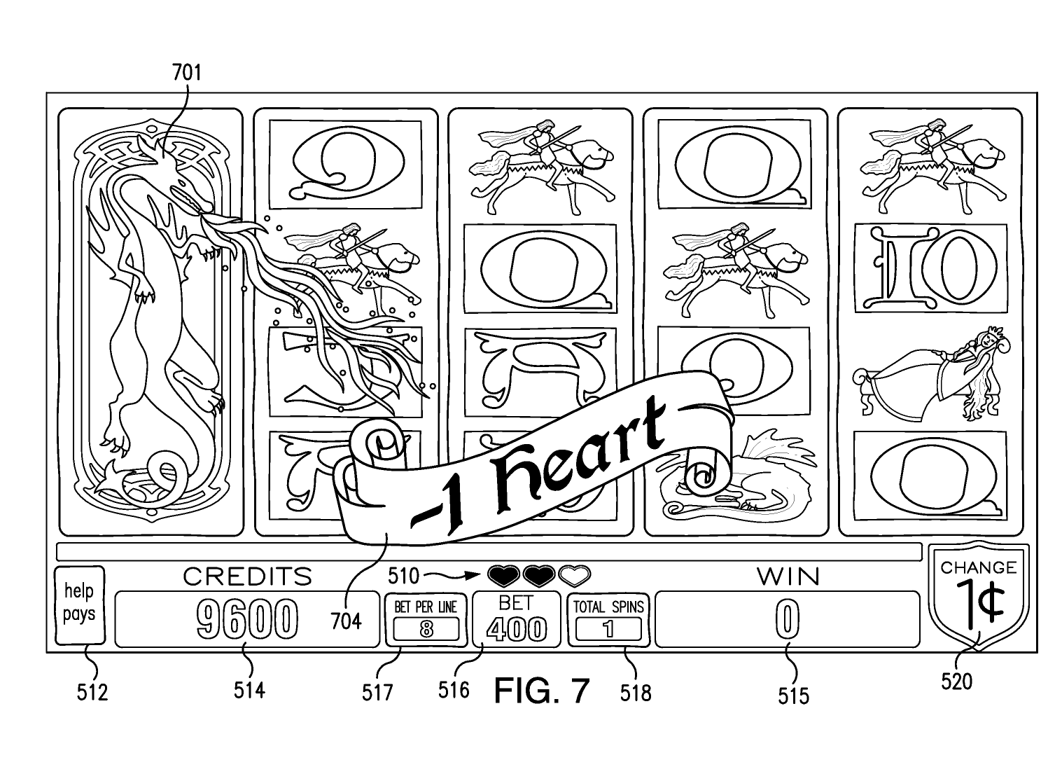

FIG. 7 provides an example graphic for a decrement-type outcome obtained for a play in the indeterminate mode (at 406 in FIG. 4, for example). In this case the decrement type outcome is shown with a multi-symbol location dragon symbol 701 on the first reel 501 of the reel-type display. This outcome decrements the meter value as indicated by the reduced number of illuminated hearts shown in meter value display 510. Also the outcome is accompanied by a decrement graphic 704 comprising a scroll representation with the label “−1 heart.” Although not necessary according to the present invention, symbol 701 may nudge to the position shown in FIG. 7 in the event any part of the symbol stops in a visible area of reel 501 for a given play.

It should be noted that the present indeterminate play arrangement is not limited to use with reel-type games such as the video reel-type game shown in FIGS. 5-7. Rather, the game presented in the indeterminate play mode for a given implementation of the invention may comprise a reel-type game, a playing card game, a dice game, a simulated competition, roulette, bingo, or any other type of game. Furthermore, the game played immediately prior to entering the indeterminate play mode may be an entirely different type of game than the game played in the indeterminate play mode. The game presented immediately following the game presented in the indeterminate play mode may also be a different type of game and may be different from the game presented before entering the indeterminate play mode.

Numerous variations are also possible within the indeterminate play mode. For example, setting the meter value may also set a maximum number of meter value indicators which display an indication of the meter value. The heart display meter value indicator 510 may be used to describe this variation. According to an embodiment of this maximum meter value variation, the maximum number of hearts to track the meter value may be fixed. That is, when the meter value is set (as indicated at process block 405 in FIG. 4), the indicator may be limited to the three hearts shown in FIGS. 5-7 and the hearts may be illuminated to provide an indication of the meter value. If all of the three hearts are already illuminated and the outcome for the next play in the indeterminate mode is an increment-type outcome, the meter value may not be incremented. Rather, the meter value would still be indicated by the three illuminated hearts. For each decrement-type outcome, however, one of the illuminated hearts would be de-illuminated to reflect that the meter value has been decremented. This would continue until none of the hearts are illuminated to indicate the end meter value which causes the gaming machine to be switched out of the indeterminate play mode.

Other implementations of the invention may include an arrangement in which the meter value is unlimited. Using the heart meter example still, rather than indicating the meter value by a number of illuminated hearts out of some fixed number of displayed hearts, the number of hearts might not be fixed and a heart would be added to the meter value indicator display in response to each increment-type outcome in the indeterminate play mode.

In yet other forms of the invention, plays in the indeterminate play mode need not be played out in one continuous sequence of plays at a gaming machine. For example, a process according to the invention may allow a player to make a few plays in the indeterminate play mode and then, prior to reaching the end meter value, return to play a game which is not in the indeterminate play mode. The gaming machine may then be returned to the indeterminate play mode for the player to continue play in that mode until the meter value reaches the predetermined end value.

Numerous graphic effects may also be used in various implementations of indeterminate play according to the invention. For example, where the outcomes are displayed on a video display device, or a light-transmissive video display device is associated with underlying mechanical reels, various animations may be shown on the video display device in connection with showing an outcome for a play in the indeterminate mode. An example of such an animation is shown in FIG. 7 with the dragon symbol 701 animating to breath fire into adjacent portions of the display area 500. As another example, the princess symbol 601 in FIG. 6 may also animate in some fashion when it lands as shown in that figure.

As used in the foregoing description and the following claims, the terms “comprising,” “including,” “carrying,” “having,” “containing,” “involving,” and the like are to be understood to be open-ended, that is, to mean including but not limited to. Any use of ordinal terms such as “first,” “second,” “third,” etc., in the claims to modify a claim element does not by itself connote any priority, precedence, or order of one claim element over another, or the temporal order in which acts of a method are performed. Rather, unless specifically stated otherwise, such ordinal terms are used merely as labels to distinguish one claim element having a certain name from another element having a same name (but for use of the ordinal term).

The above-described example embodiments are intended to illustrate the principles of the invention, but not to limit the scope of the invention. Various other embodiments and modifications to these preferred embodiments may be made by those skilled in the art without departing from the scope of the present invention.

1. A method for controlling play in a wagering game, the method including:
(a) receiving one or more game play inputs in a wagering game through a player input system of a gaming machine, each game play input defining a wager for a play of the game and initiating that respective play of the game;
(b) in response to a trigger condition, setting a meter value at an initial value for an indeterminate play mode of the gaming machine, the initial value comprising a minimum number of plays in the indeterminate play mode;
(c) receiving an indeterminate play input through the player input system of the gaming machine, the indeterminate play input initiating a respective play in the indeterminate play mode;
(d) receiving an outcome for the respective play in the indeterminate play mode, the received outcome comprising one of a first outcome type, a second outcome type, or a third outcome type;
(e) in response to the received outcome for the respective play in the indeterminate play mode, incrementing the meter value if the received outcome comprises the first outcome type, decrementing the meter value if the received outcome comprises the second outcome type, and leaving the meter value unchanged if the received outcome comprises a third outcome type;
(f) repeating steps (c), (d), and (e) until the meter value reaches a predetermined end value, and in response to reaching the predetermined end value, placing the gaming machine in a mode different from the indeterminate play mode.

2. (canceled)

3. The method of claim 1 wherein:
(a) the trigger condition includes obtaining a trigger outcome for the respective play of the wagering game where the trigger outcome is included in a predefined trigger outcome set which represents a subset of all possible outcomes for the respective play of the wagering game; and
(b) the step of setting the meter value for the indeterminate play mode includes selecting one of at least two different values depending upon the particular trigger outcome obtained for the respective play of the wagering game within the predefined trigger outcome set.

4. The method of claim 3 wherein the step of setting the meter value for the indeterminate play mode includes selecting one of at least three different values.

5. The method of claim 3 wherein:
(a) the play in the indeterminate play mode is a play of a reel-type game displayed at the gaming machine; and
(b) the predefined trigger outcome set includes a set of outcomes defined by a number of scatter symbols present in the particular outcome obtained for the respective play of the wagering game.

6. The method of claim 1 further including displaying a graphic representation of the meter value at a display device of the gaming machine for at least a portion of the time the gaming machine is in the indeterminate play mode.

7. The method of claim 6 further including, in addition to incrementing the meter value when the received outcome comprises the first outcome type, displaying an increment graphic animation at the gaming machine separate from the graphic representation of the meter value, or producing an increment audio output, or both displaying the increment graphic animation and producing the increment audio output.

8. The method of claim 6 further including, in addition to decrementing the meter value which the received outcome comprises the second outcome type, displaying a decrement graphic animation at the gaming machine separate from the representation of the meter value, or producing a decrement audio output, or both displaying the decrement graphic animation and producing the decrement audio output.

9. (canceled)

10. A gaming machine including:
(a) at least one display device;
(b) a player input system;
(c) at least one processor; and
(d) at least one memory device storing instructions executable by the at least one processor to:
(i) receive one or more game play inputs in a wagering game through a player input system of a gaming machine, each game play input defining a wager for a play of the game and initiating that respective play of the game;
(ii) in response to a trigger condition, set a meter value at an initial value for an indeterminate play mode of the gaming machine, the initial value comprising a minimum number of plays in the indeterminate play mode;
(iii) receive an indeterminate play input through the player input system of the gaming machine, the indeterminate play input initiating a respective play in the indeterminate play mode;
(iv) receive an outcome for the respective play in the indeterminate play mode, the received outcome comprising one of a first outcome type, a second outcome type, or a third outcome type;
(v) in response to the received outcome for the respective play in the indeterminate play mode, increment the meter value if the received outcome comprises the first outcome type, decrement the meter value if the received outcome comprises the second outcome type, and leave the meter value unchanged if the received outcome comprises the third outcome type;
(vi) repeat (iii), (iv), and (v) until the meter value reaches a predetermined end value, and in response to reaching the predetermined end value, place the gaming machine in a mode different from the indeterminate play mode.

11. (canceled)

12. The gaming machine of claim 10 wherein:
(a) the trigger condition includes receiving a trigger outcome for the respective play of the wagering game where the trigger outcome is included in a predefined trigger outcome set which represents a subset of all possible outcomes for the respective play of the wagering game; and
(b) the meter value for the indeterminate play mode is set by selecting one of at least two different values depending upon the particular trigger outcome obtained for the respective play of the wagering game within the predefined trigger outcome set.

13. The gaming machine of claim 12 wherein the meter value for the indeterminate play mode is set by selecting one of at least three different values.

14. The gaming machine of claim 12 wherein:
(a) each play in the indeterminate play mode is a play of a reel-type game displayed at the gaming machine; and
(b) the predefined trigger outcome set includes a set of outcomes defined by a number of scatter symbols present in the particular outcome obtained for the respective play of the wagering game.

15. The gaming machine of claim 10 wherein the instructions are also executable by the at least one processor to cause a graphic representation of the meter value to be displayed at the at least one display device of the gaming machine for at least a portion of the time the gaming machine is in the indeterminate play mode.

16. A program product stored on one or more computer readable, non-transitory data storage devices, the program product including:
(a) player input program code executable by at least one processor to receive game play inputs entered through a gaming machine, each game play input initiating a play in a respective game presented through the gaming machine, at least one game comprising a wagering game;
(b) game program code executable by the at least one processor to generate an outcome for each respective play;
(c) display program code executable by the at least one processor to cause at least one display device associated with the gaming machine to display a graphical representation of the outcome for each respective play;
(d) indeterminate play program code executable by the at least one processor to,
(i) in response to a trigger condition, set a meter value at an initial value for an indeterminate play mode of the gaming machine, the initial value comprising a minimum number of plays in the indeterminate play mode,
(ii) in response to a respective outcome for a respective play while the gaming machine is in the indeterminate play mode, incrementing the meter value if that respective outcome comprises a first outcome type, decrementing the meter value if that respective outcome comprises a second outcome type, and leaving the meter value unchanged if that respective outcome comprises a third outcome type, and
(iii) repeating step (ii) for each respective outcome while the gaming machine is in the indeterminate play mode until the meter value reaches a predetermined end value, and in response to reaching the predetermined end value, placing the gaming machine in a mode different from the indeterminate play mode; and
(d) payout program code executable by the at least one processor to award a prize for each respective outcome comprising a winning outcome.

17. The program product of claim 16 wherein each outcome generated by the game program code when the gaming machine is in the indeterminate play mode is included in a first set of potential outcomes, and each outcome generated by the game program code when the gaming machine is not in the indeterminate play mode is included in a second set of potential outcomes different from the first set of potential outcomes.

18. The program product of claim 16 wherein each graphical representation displayed at the gaming machine when the gaming machine is in the indeterminate play mode is included in a first set of potential graphical representations, and each graphical representation displayed at the gaming machine when the gaming machine is not in the indeterminate play mode is included in a second set of potential graphical representations different from the first set of graphical representations.

19. The program product of claim 17 wherein:
(a) the trigger condition includes receiving a trigger outcome for the respective play of the game where the trigger outcome is included in a predefined trigger outcome set which represents a subset of all possible outcomes for the respective play of the wagering game; and
(b) the meter value for the indeterminate play mode is set by selecting one of at least two different values depending upon the particular trigger outcome obtained for the respective play of the wagering game within the predefined trigger outcome set.

20. The program product of claim 19 wherein the meter value for the indeterminate play mode is set by selecting one of at least three different values.

21. The method of claim 1 wherein:
(a) there is a maximum meter value for the indeterminate play mode; and
(b) incrementing the meter value if the received outcome comprises the first type outcome is performed when the meter value is less than the maximum meter value and is not performed when the meter value is at the maximum meter value.

22. The method of claim 1 further including enabling one or more additional plays in the indeterminate play mode in response to reaching the end meter value and prior to placing the gaming machine in the mode different from the indeterminate play mode.

23. The method of claim 1 further including:
(a) exiting the indeterminate play mode prior to the meter value reaching the predetermined end value;
(b) re-entering the indeterminate play mode after having exited the indeterminate play mode prior to the meter value reaching the predetermined end value, re-entering the indeterminate play mode facilitating repeating steps (c), (d), and (e) of claim 1 until the meter value reaches the predetermined end value; and
(c) conducting one or more plays at the gaming machine after exiting the indeterminate play mode and before re-entering the indeterminate play mode.
